(19) United States
(12) Patent Application Publication
(10) Pub. No.: US 2005/0178044 A1
(43) Pub. Date: Aug. 18, 2005

(54) Fishing lure

(76) Inventor: Theodore J. Stechschulte, Maumee, OH (US)

Correspondence Address: MARSHALL & MELHORN, FOUR SEAGATE, EIGHT FLOOR, TOLEDO, OH, 43604, US

(21) Appl. No.: 11/032,364

(22) Filed: Jan. 10, 2005

Related U.S. Application Data
(60) Provisional application No. 60/535,451, filed on Jan. 9, 2004.

(51) Int. Cl. A01K 85/00

(52) U.S. Cl. 43/42.32

(57) ABSTRACT

A fishing lure body includes a left-hand side and a right-hand side, the left-hand side of the body bearing a first decorative design and the right-hand side of the body bearing a second decorative design. The first decorative design is perceptibly distinct from the second decorative design. Utilizing the fishing lure body provides an effective way for an angler to place two designs or patterns in the water at the same time on one lure, since those fish situated on one side of the lure will perceive the first design, while those fish situated on the opposite side of the lure will perceive the second design.

### RELATED APPLICATION

This application is claiming the benefit, under 35 U.S.C. § 119(e), of the provisional application filed Jan. 9, 2004 under 35 U.S.C. § 111(b), which was granted Ser. No. 60/535,451. This provisional application is hereby incorporated by reference.

### BACKGROUND OF THE INVENTION

Fishing lures are typically cast and retrieved or trolled in the water. There are a wide variety of designs. Some float on the surface, some sink to the bottom and some dive when pulled forward. There are also a wide variety of shapes. Regardless, all fishing lures are, in effect, placed in the water in a manner that is intended to allow the prey species to see them.

Lure design is an artistic expression that seeks to attract and then trigger the feeding or attack instincts in targeted species of fish. Historically, that artistic expression was used to cover the entire lure body in a manner that was homogeneous from left to right or side to side. In other words, when looking at a lure, the user would see a similar design mirrored from one side to the other side. In the water, a fish that saw a given lure would, if it swam completely around the bait, see the same image on the left side approximately mirrored on the right side of the lure body.

### BRIEF SUMMARY OF THE INVENTION

The invention is directed to the body portion of a fishing lure. The fishing lure body of the invention includes a left-hand side and a right-hand side, the left-hand side of the body bearing a first decorative design and the right-hand side of the body bearing a second decorative design. The first decorative design is perceptibly distinct from the second decorative design.

Utilizing a fishing lure body in accordance with the invention provides an effective way for an angler to place two designs or patterns in the water at the same time on one lure, since those fish situated on one side of the lure will perceive the first design, while those fish situated on the opposite side of the lure will perceive the second design.

### BRIEF DESCRIPTION OF THE DRAWINGS

The advantages of the invention will become readily apparent to those skilled in the art from the following detailed description of a preferred embodiment when considered in the light of the accompanying drawings, each of which is somewhat schematic.

FIG. 1 is a top view of an embodiment of the fishing lure body of the invention.

FIG. 2 is a left-hand side view of the fishing lure body shown in FIG. 1.

FIG. 3 is a right-hand side view of the fishing lure body shown in FIG. 1.

FIG. 4 is a top view of an alternate embodiment of the fishing lure body of the invention.

FIG. 5 is a left-hand side view of the fishing lure body shown in FIG. 4.

FIG. 6 is a right-hand side view of the fishing lure body shown in FIG. 4.

FIG. 7 is a top view of a further embodiment of the fishing lure body of the invention.

FIG. 8 is a left-hand side view of the fishing lure body shown in FIG. 7.

FIG. 9 is a right-hand side view of the fishing lure body shown in FIG. 7.

### DETAILED DESCRIPTION OF THE INVENTION

The invention is directed to fishing lures that might be termed “contrast pairs fishing lures.” The idea is to place two unique (with respect to one another) and contrasting designs on a single fishing lure body that may be generally related around the vertical centerline of the lure body. The designs can be generated using any available technology, but they will be different from one another in appearance to a degree that would be noticeable to the average person; that is, the two designs will be “perceptibly distinct” from one another. The respective designs may, as examples, be applied by painting, molding, greyfilm, stamping, pad printing, etc. The respective designs may also be in the form of perceptibly distinct color schemes in the hair or hair-like strands on the left and right-hand sides of a lure such as a bucktail type lure.

The concept of contrast pairs in accordance with the invention seeks to exploit the way in which a population of fish sees a single lure. Thus, the invention seeks to exploit the fact that fish by their nature do not swim around their prey. They see the intended target, and if attracted, agitated or otherwise inclined, they generally attack from the side, taking the object (i.e. fish, salamander, muskrat, bird, lure, etc.) in their mouth attempting to eat or maim it. The individual fish that ultimately strikes the lure is typically one among many to be found in the vicinity of the lure. That is, in any given body of water there is a population of target fish. That population is dispersed throughout the volume of water. While fishing by casting or trolling, lures are retrieved through the water, and therefore through the population of dispersed fish. Accordingly, some fish are above the lure, some fish are below the lure, some fish are in front of the lure, some fish are behind the lure, some fish are to the left of the lure and some fish are to the right of the lure. Contrast pairs, lures that are manufactured with two unique (i.e., contrasting with one another) designs, patterns and/or color schemes, one on the left side (Design A) and one on the right side (Design B), allow the population of fish to see, what appears, as two different lures in the water. The fish situated to the left of the lure will see Design A, while the fish situated to the right of the lure will see Design B.

This aspect is important to anglers for several reasons. First, by law anglers are limited in terms of how many lines they may place in the water and how many lures each line can hold. Second, fish react to lure designs and patterns. It is a proven fact that fish respond to patterns, designs and colors and that their response varies subject to a variety of factors including weather (host of variables), light level, water depth, water clarity and body of water elements (i.e. native species, vegetation, etc.). It is normal for fishermen to change lures until they find something that is working; i.e., some color or pattern that the fish are reacting to that day under whatever conditions might exist.

The fishing lures in accordance with the invention are an effective way for the angler to place two designs or patterns in the water at the same time on one lure. In effect, the lure body of the invention doubles the lure's potential attractiveness and cuts the amount of trial and error in half.

The invention stipulates two different patterns or designs on the two opposing sides of a given lure body, the left-hand side and right-hand side of the lure body, generally on either side of a vertical plane running along the length of the lure body. The specific design on either side of the lure body is not critical to the invention. It is the presentation of two contrasting designs, patterns, and/or color schemes on opposing sides situated approximately around the vertical centerline when viewed from the front or back of a single lure.

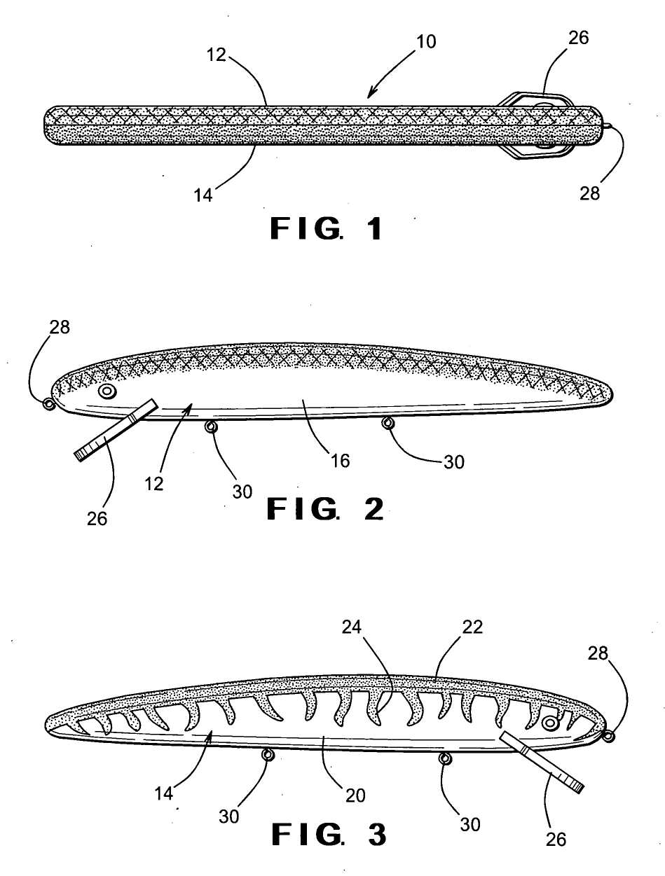

Examples of fishing lure bodies provided with contrasting pair designs in accordance with the invention are illustrated in the drawings. FIG. 1 illustrates a first embodiment of a fishing lure body 10 in accordance with the invention. As shown, the body 10 is elongated and generally simulates the shape of a small prey fish species. The body 10 includes a left-hand side 12 and a right-hand side 14. In the embodiment illustrated, the left-hand side 12 and right-hand side 14 are defined by a plane extending vertically from bottom to top through the longitudinal centerline of the body 10, although the left and right-hand sides of the body need not be so specifically defined in the lures according to the invention.

The left-hand side 12 of the body 10 is provided with a first design, in this case a region 16 of a first color extending along a lower portion of the body and another color on a region 18 extending along an upper portion of the length of the body 10. For example, the region 16 might be white and the region 18 a dark green with simulated scales.

The right-hand side 14 of the body 10 is provided with a second design, in this case a region 20 of one or more colors extending along a lower portion of the body and another region 22 extending along an upper portion of the length of the body 10, having wavy lines 24 extending generally downward. The lower region 20 could, for example, include a lower yellow portion and an upper orange portion, both running the length of the body 10. The upper region 22 and lines 24 could be black.

Thus, the design applied to the left-hand side 12 of the body 10 is perceptibly distinct from the design applied to the right-hand side 14, so that the lure body 10 appears as a first lure from the one side and as a different lure when viewed from the opposite side.

The lure body 10 may be provided with additional features and hardware as known to those skilled in the art. For example, the body 10 may be provided with a lip 26 extending from a front end of the body for altering the position of the lure as it is drawn through the water. The body 10 would also typically include an eye 28 or other line carrier structure for affixing the lure to fishing line, as well as one or more hook carrier structures, such as the eyelets 30, for securing hooks (not shown) to the body 10 of the lure.

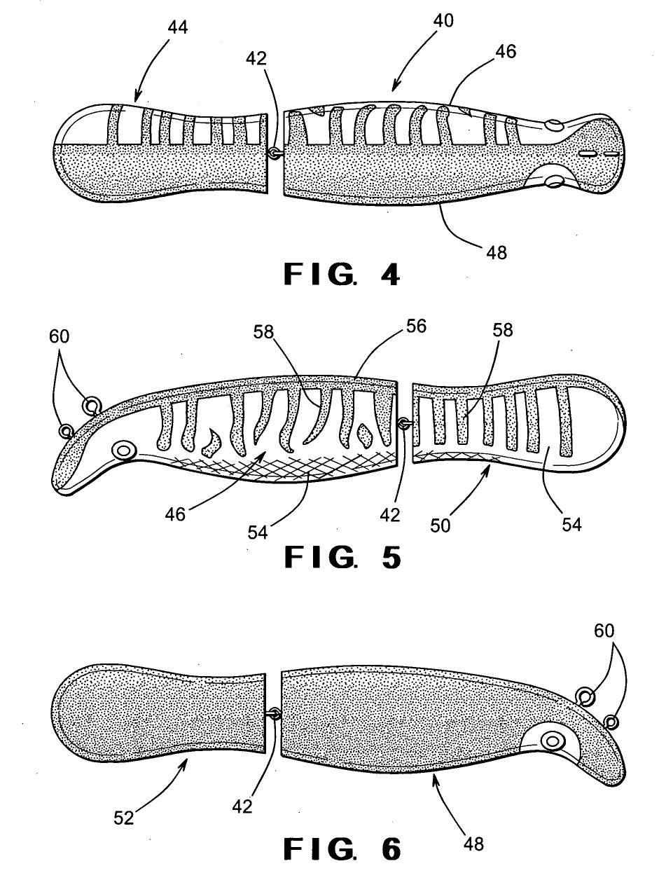

Another embodiment is shown in FIGS. 4-6. In this embodiment, the fishing lure is a jointed lure, so that a fishing lure body 40 is connected by a joint 42 to a second fishing lure body 44. The body 40 includes a left-hand side 46 and a right-hand side 48. Likewise, the second body 44 includes a left-hand side 50 and a right-hand side 52. In the embodiment illustrated, the left and right-hand sides of both the first and second bodies 40 and 44 are defined by a plane extending vertically from bottom to top through the longitudinal centerline of the respective body, although again the left and right-hand sides of the bodies need not be so specifically defined in the lures according to the invention.

In addition, the left-hand sides of both the first and second bodies 40 and 44 have been provided with a matching design, while the right-hand sides of both the first and second bodies 40 and 44 have been provided with a matching design that is perceptibly distinct from the design on the left-hand sides of both the first and second bodies 40 and 44. However, the corresponding sides of the bodies need not be matching in accordance with the invention.

As illustrated in FIG. 5, the left-hand side of the bodies 40, 44 is provided with a region 54 of a one or more colors, such as white fading into a yellow, extending along a lower portion of the body, and another region 56 extending along an upper portion of the length of the bodies 40, 44 having a number of lines 58 extending generally downward.

The right-hand sides of the bodies 40, 44, shown in FIG. 6, are provided with a second design, in this case, as an example, a black background with gray/silver speckles. Thus, the design applied to the left-hand sides of the bodies 40, 44 is perceptibly distinct from the design applied to the right-hand sides, so that the lure appears as a first lure from one side and as a different lure when viewed from the opposite side.

The lure bodies 40, 44 may be provided with additional features and hardware as known to those skilled in the art. For example, the body 40 may be provided with one or more eyelets 60.

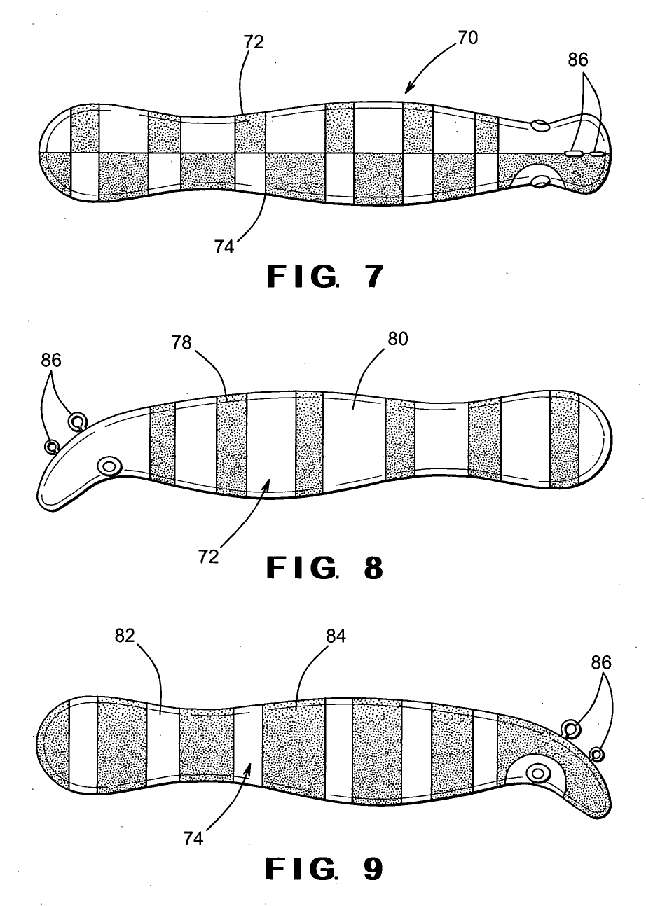

A further embodiment of the invention is illustrated in FIGS. 7-9. In this embodiment, the lure body 70 is a single piece body having a left-hand side 72 and a right-hand side 74. As illustrated, the left-hand side 72 and right-hand side 74 are defined by a plane extending vertically from bottom to top through the longitudinal centerline of the body 70, although the left and right-hand sides of the body need not be so specifically defined in the lures according to the invention.

The left-hand side 72 of the body 70 is provided with a first design, in this case a first set of thinner, vertically-extending stripes 76 alternating with a second set of thicker, vertically-extending stripes 80. In this case, the thinner stripes 78 are black and the thicker stripes 80 are yellow.

The right-hand side 74 of the body 70 is provided with a second design, in this case first set of thinner, vertically-extending stripes 82 alternating with a second set of thicker, vertically-extending stripes 84. On this side, the thinner stripes 82 are yellow and the thicker stripes 84 are black.

Thus, in this embodiment, the design applied to the left-hand side 72 of the body 70 is distinct from the design applied to the right-hand side 74 solely on the basis of color. The respective designs on the left and right-hand sides are still perceptibly distinct from one other, although this embodiment may not provide as significant an advantage as those embodiments of the invention in which the respective designs of the left and right-hand sides of the lure body are perceptibly distinct in pattern and color. Thus, in most preferred embodiments of the invention, the left and right-hand sides of the lure body are perceptibly distinct in pattern and color.

Again, the lure body 70 may be provided with additional features and hardware as known to those skilled in the art. For example, the body 70 may be provided with one or more eyelets 86.

In accordance with the provisions of the patent statutes, the invention has been described in what is considered to represent its preferred embodiments. However, it should be noted that the invention could be practiced otherwise than as specifically illustrated and described without departing from its spirit or scope. For example, the invention may be applied to virtually any type of fishing lure body, including single-piece, jointed, hard, soft, soft tail, bucktail, and other types of lures.

1. A fishing lure comprising a fishing lure body having a length, a left-hand side and a right-hand side, the left-hand side of the body bearing a first decorative design and the right-hand side of the body bearing a second decorative design, the first decorative design being perceptibly distinct from the second decorative design.

2. The fishing lure as set forth in claim 1, wherein the first and second decorative designs are perceptibly distinct from one another solely on the basis of color.

3. The fishing lure as set forth in claim 1, wherein the first decorative design utilizes a color scheme that is perceptibly distinct from a color scheme utilized in the second decorative design.

4. The fishing lure as set forth in claim 1, wherein the first decorative design utilizes a color scheme and pattern that are perceptibly distinct from a color scheme and pattern utilized in the second decorative design.

5. The fishing lure as set forth in claim 1, wherein the fishing lure is a jointed lure, the fishing lure body being connected by a joint to a second fishing lure body.

6. The fishing lure as set forth in claim 5, wherein the second fishing lure body has a left-hand side and a right-hand side, the left-hand side of the body bearing a decorative design and the right-hand side of the body bearing a decorative design that is perceptibly distinct from the decorative design on the left-hand side of the second fishing lure body.

7. The fishing lure as set forth in claim 1, wherein the body is a hard body formed of a molded polymeric material.

8. The fishing lure as set forth in claim 1, wherein the body is a soft body formed of soft, pliable polymeric material.

9. The fishing lure as set forth in claim 1, wherein the first and second designs simulate distinct prey species.

10. The fishing lure as set forth in claim 1, further comprising a line carrier affixed to a front end of the body and at least one hook carrier affixed to the body.

11. The fishing lure as set forth in claim 1, further comprising a lip extending from a front end of the body.
